(19) United States
(12) Patent Application Publication
(10) Pub. No.: US 2025/0167553 A1
(43) Pub. Date: May 22, 2025

(54) SHARED ENERGY STORAGE SYSTEM OPTIMIZATION METHOD AND SYSTEM FOR COMPREHENSIVE ENERGY MICROGRIDS

(71) Applicant: STATE GRID NANJING POWER SUPPLY COMPANY, NANJING (CN)

(72) Inventors: Hai Qing GAN, Nanjing (CN); Yu WANG, Nanjing (CN); Yucheng REN, Nanjing (CN); Kun CHEN, Nanjing (CN); Hangtong ZHANG, Nanjing (CN); Baligen TALIHATI, Nanjing (CN); Jie SONG, Nanjing (CN); Yuanhui CHEN, Nanjing (CN); Yaojie SUN, Nanjing (CN)

(73) Assignee: STATE GRID NANJING POWER SUPPLY COMPANY, NANJING (CN)

(21) Appl. No.: 18/643,001

(22) Filed: Apr. 23, 2024

(30) Foreign Application Priority Data
Nov. 20, 2023 (CN) 202311546739.8

(51) Int. Cl. H02J 3/28; H02J 3/00

(52) U.S. Cl. CPC H02J 3/28; H02J 3/008; H02J 2203/10; H02J 2203/20

(57) ABSTRACT

The application discloses a shared energy storage system optimization method and system for comprehensive energy microgrids, which take into account a shared energy storage-multi-microgrid system model invested by a third party. The comprehensive energy microgrids are regional energy systems integrating multiple energy sources and adjustable loads, including CHP, heat storage, power storage and distributed renewable energy. Shared energy storage is invested by a third part, serve as a power price publisher, and is limited by power price boundaries. The method takes into account a carbon emission and trading model to reduce carbon emission. Costs of the microgrids include a power/gas buying cost, a demand response cost, a carbon trading cost, and an operating cost of CHP units. Finally, a minimum cost solution is resolved by a MILP algorithm. The invention realizes microgrid scheduling and improves the economic efficiency and environmental friendliness of the comprehensive energy microgrids.

### BACKGROUND OF THE INVENTION

### 1. Technical Field

The application relates to the technical field of power systems, in particular to a shared energy storage system optimization method and system for comprehensive energy microgrids.

### 2. Description of Related Art

In the modern society, the sustainability and high efficiency of the power system become increasingly more important. Comprehensive energy microgrids, as regional energy systems integrating multiple energy sources and controllable loads, include combined heat and power (CHP), heat storage, power storage, distributed renewable energy and the like. These microgrids can provide multiple energy sources to satisfy the demand of different loads. However, the optimization and management of the microgrids are always a complex task, particularly under the condition where third-party investment and carbon emission are taken into account.

The background art of the invention includes the concept of the comprehensive energy microgrid, CHP, carbon capture and storage (CCS), power to gas (P2G), carbon emission and carbon trading. The comprehensive energy microgrid is a system integrating multiple energy sources, the CHP has energy saving and environmental protection effects, and the CCS is used for reducing carbon dioxide emission, the P2G is used for converting electric power into methane, and the carbon emission and carbon trading relate to trading and management of carbon emission permits.

### BRIEF SUMMARY OF THE INVENTION

The application provides a shared energy storage system optimization method and system for comprehensive energy microgrids, which establish a cost model of a shared energy storage-multi-microgrid system taking into account third-party investment and obtain a minimum operating cost of microgrids by resolving optimal values of variables in the cost model, thus reducing the operating cost of the microgrids.

The technical solution of the application is as follows:

In one aspect, the application provides a shared energy storage system optimization method for comprehensive energy microgrids, comprising the following steps:
constructing a cost model of a shared energy storage-multi-microgrid system taking into account third-party investment, and setting constraints; and
resolving optimal values of variables in the cost model, and controlling devices in the shared energy storage-multi-microgrid system according to the optimal values.

Further, the constraints of the shared energy storage-multi-microgrid system comprise:
in order to limit power prices, including a minimum power price, a maximum power price and an average power price, set by a shared energy storage supplier, as a power price publisher, to prevent the power prices from being too high, a boundary constraint of a power buying price:

$${γ}_{{e}_{buy}}^{min} \leq {γ}_{{e}_{buy}}^{i , t} \leq {γ}_{{e}_{buy}}^{max} \qquad ( 1 )$$

where, γ_{e_buy}^{i,t} is a power buying price at which a microgrid i buys power from shared energy storage; γ_{e_buy}^{min} is a minimum value of the power buying price; γ_{e_buy}^{max} is a maximum value of the power buying price;
a boundary constraint of a power selling price:

$${γ}_{{e}_{s e l l}}^{min} \leq {γ}_{{e}_{s e l l}}^{i , t} \leq {γ}_{{e}_{s e l l}}^{max} \qquad ( 2 )$$

where, γ_{e_sell}^{i,t} is a power selling price at which the microgrid i sells power to the shared energy storage; γ_{e_sell}^{min} is a minimum value of the power selling price; γ_{e_sell}^{max} is a maximum value of the power selling price;
constraints of an average power buying/selling price:

$$\frac{{\sum }_{t = 1}^{24} {γ}_{{e}_{buy}}^{i , t}}{24} \leq {γ}_{{e}_{buy}}^{ave\_max} \qquad ( 3 )$$

$$\frac{{\sum }_{t = 1}^{24} {γ}_{{e}_{s e l l}}^{i , t}}{24} \leq {γ}_{{e}_{s e l l}}^{ave\_max} \qquad ( 4 )$$

where, γ_{e_buy}^{ave_max} is an upper limit of an average price at which the microgrid i buys power from the shared energy storage; γ_{e_sell}^{ave_max} is an upper limit of an average price at which the microgrid i sells power to the shared energy storage;
energy balance constraints of the shared energy storage:

$${E}_{S E S}^{1} = {E}_{S E S}^{0} + {μ}_{{s}_{charge}} {P}_{{s}_{charge}}^{t} - \frac{{P}_{{s}_{d i scharge}}^{t}}{{μ}_{{s}_{d i s c harge}}} \qquad ( 5 )$$

$${E}_{S E S}^{t} = {E}_{S E S}^{t} + {μ}_{{s}_{c harge}} {P}_{{s}_{c harge}}^{t} - \frac{{P}_{{s}_{d i s c harge}}^{t}}{{μ}_{{s}_{d i s c harge}}} \qquad ( 6 )$$

where, E_{SES}¹ is a power quantity of the shared energy storage at a time t=1; E_{SES}⁰ is an initial energy value of the shared energy storage; μ_{s_charge} is charge efficiency of the shared energy storage; P_{s_charge}^{t} is a charge power of the shared energy storage; P_{s_discharge}^{t} is a discharge power of the shared energy storage; μ_{s_discharge} is discharge efficiency of the shared energy storage;
an upper and lower boundary constraint of energy of the shared energy storage:

$${E}_{S E S}^{min} \leq {E}_{S E S}^{t} \leq {E}_{S E S}^{max} \qquad ( 7 )$$

where, E_{SES}^{t} is an energy value of the shared energy storage at the time t; E_{SES}^{min} is a minimum energy value of the shared energy storage; E_{SES}^{max} is a maximum energy value of the shared energy storage;
constraints of the charge power and the discharge power:

$$0 \leq {P}_{{s}_{c h a r g e}}^{t} \leq {S}_{flag} * {P}_{{s}_{c h a r g e}}^{max} \qquad ( 8 )$$

$$0 \leq {P}_{{s}_{d i s c h a r g e}}^{t} \leq ( 1 - {S}_{flag} ) * {P}_{{s}_{d i s c h a r g e}}^{max} \qquad ( 9 )$$

where, S_{flag} is a charge and discharge flag of the shared energy storage, which is a variable from 0 to 1 and is configured to define that only charge/discharge is allowed within a same time; p_{s_charge}^{max} is a maximum charge power of the shared energy storage; P_{s_discharge}^{max} is a maximum discharge power of the shared energy storage;
a power balance constraint of the shared energy storage:

$${P}_{{s}_{c harge}}^{t} - {P}_{{s}_{d i s chage}}^{t} = {P}_{{s}_{{buy}_{f G}}}^{t} - {P}_{{s}_{s e l {l}_{t o G}}}^{t} + {\sum }_{i = 1}^{U} {P}_{b u {y}_{fS}}^{i , t} - {\sum }_{i = 1}^{U} {P}_{s e l {l}_{t o s}}^{i , t} \qquad ( 10 )$$

where, P_{s_buy_fG}^{t} is a buying power at which the shared energy storage buys power from a power grid of; P_{s_sell_toG}^{t} is a selling power at which the shared energy storage sells power to the power grid; P_{buy}_{_{fs}}^{i,t} is an electric power bought by the microgrid i from the shared energy storage by; Pₛₑₗₗ_{_{toS}}^{i,t} is an electric power sold by the microgrid i to the shared energy storage; U is a total number of microgrids trading with the shared energy storage;
constraints for the shared energy storage to buy and sell power to a main power grid:

$$0 \leq {P}_{{s}_{{buy}_{f G}}}^{t} \leq {P}_{{s}_{{buy}_{f G}}}^{max} \qquad ( 11 )$$

$$0 \leq {P}_{{s}_{s e l {l}_{t o G}}}^{t} \leq {P}_{{s}_{s e l {l}_{toG}}}^{max} \qquad ( 12 )$$

where, P_{s_buy_fG}^{max} is a maximum power at which the shared energy storage buys power from the power grid; P_{s_sell_toG}^{max} is a maximum power at which the shared energy storage sells power to the power grid.

Further, the method takes into account a CHP model combining CCS and P2G, and the shared energy storage-multi-microgrid system comprises the CHP model, and in the CHP model:
a gas turbine set burns natural gas to generate power, and for a microgrid i at a time t, a power generation model of the gas turbine set is:

$${P}_{C H P}^{i , t} = {V}_{C H P}^{i , t} η Q \qquad ( 13 )$$

where, P_{CHP}^{i,t} is a power generation rate of the microgrid i at the time t, V_{CHP}^{i,t} is natural gas consumption, and η is power generation efficiency of the gas turbine set; Q is a heat value of the natural gas;
because of the characteristic of fixing power based on heat of the gas turbine set, an electrothermal coupling constraint is:

$$max \{ {P}_{C H P}^{min} - {k}_{1} {H}_{C H P}^{i , t} , m ( {H}_{CHP}^{i , t} - {H}_{i , 0} ) \} \leq {P}_{C H P}^{i , t} \leq {P}_{C H P}^{max} - {k}_{2} {H}_{C H P}^{i , t} \qquad ( 14 )$$

where, p_{CHP}^{min} is a minimum power generation rate of a CHP unit; p_{CHP}^{max} is a maximum power generation rate of the CHP unit; H_{CHP}^{i,t} is a heat generation rate of the CHP unit; k₁ is an electrothermal conversion coefficient in case of the minimum power generation rate of the CHP unit; k₂ is an electrothermal conversion coefficient in case of the maximum power generation rate of the CHP unit; m is a linear supply slope of a thermoelectric power of CHP; H_{i,0} is a heat power in case of the minimum power generation rate of the CHP unit;
in the CHP system comprising a CCS and a P2G device, power generated by CHP is used for satisfying demand of conventional power loads, satisfying power demand of the CCS, and satisfying power demand of the P2G device, which is expressed as:

$${P}_{C H P}^{i , t} = {P}_{load}^{i , t} + {P}_{C C S}^{i , t} + {P}_{P 2 G}^{i , t} \qquad ( 15 )$$

where, P_{CHP}^{i,t} is a power generation rate of the CHP unit; P_{load}^{i,t} is a power supply rate of the CHP unit, which is used for satisfying the demand of the conventional power loads in the microgrids; P_{CCS}^{i,t} is a power consumption rate of the CCS; P_{P2G}^{i,t} is a power consumption rate of the P2G; the CCS captures carbon dioxide generated by the CHP system and transmits the captured carbon dioxide to the P2G device; the CCS reduces the quantity of carbon dioxide generated by the CHP system, and the P2G device is able to convert the captured carbon dioxide into natural gas which is used by the CHP system;
a constraint of the power supply rate of the CHP unit is:

$${P}_{l o a d}^{min} \leq {P}_{l o a d}^{i , t} \leq {P}_{l o a d}^{max} \qquad ( 16 )$$

where, P_{load}^{min} is a minimum value of the power supply rate of the CHP unit; P_{load}^{max} is a maximum value of the power supply rate of the CHP unit;
a ramp constraint of the CHP unit is:

$${P}_{r a m p}^{min} \leq ( {P}_{l o a d}^{i , t} + {P}_{CCS}^{i , t} + {P}_{P 2 G}^{i , t} ) - ( {P}_{l o a d}^{i , t - 1} + {P}_{CCS}^{i , t - 1} + {P}_{P 2 G}^{i , t - 1} ) \leq {P}_{r a m p}^{max} \qquad ( 17 )$$

where, Pᵣₐₘₚ^{min} is a minimum value of a power ramp of the CHP unit; Pᵣₐₘₚ^{max} is a maximum value of the power ramp of the CHP unit; (P_{load}^{i,t}+P_{CCS}^{i,t}+P_{P2G}^{i,t})−(P_{load}^{i,t-1}+P_{CCS}^{i,t-1}+P_{P2G}^{i,t-1}) is the power ramp of the CHP unit;
a power range constraint of the CCS is:

$${P}_{CCS}^{min} \leq {P}_{CCS}^{i , t} \leq {P}_{CCS}^{max} \qquad ( 18 )$$

where, P_{CCS}^{min} is a minimum operating power of the CCS; P_{CCS}^{max} is a maximum operating power of the CCS;
a power range constraint of the P2G device is:

$${P}_{P 2 G}^{min} \leq {P}_{P 2 G}^{i , t} \leq {P}_{P 2 G}^{max} \qquad ( 19 )$$

where, P_{P2G}^{min} is a minimum operating power of the P2G device; P_{P2G}^{max} is a maximum operating power of the P2G device;
a power at which the P2G device to generate natural gas by means of hydrogen and carbon dioxide by consuming power is:

$${V}_{P 2 G}^{i , t} = α {P}_{P 2 G}^{i , t} \qquad ( 20 )$$

where, V_{P2G}^{i,t} is a gas generation power of the P2G device; α is a power-to-gas efficiency coefficient; V_{P2G}^{i,t} is a power of the P2G device;
the quantity of carbon dioxide acquired by the P2G device from CCS to generate natural gas under a certain power of the P2G device is:

$${W}_{C C S}^{i , t} = β {P}_{P 2 G}^{i , t} \qquad ( 21 )$$

where, W_{ccs}^{i,t} is the quantity of carbon dioxide required by the P2G device under the power P_{P2G}^{i,t}; β is a coefficient of relationship between W_{CCS}^{i,t} and P_{P2G}^{i,t};
a range constraint of the quantity of captured carbon dioxide is:

$$0 \leq {W}_{CCS}^{i , t} \leq {W}_{CCS}^{max} \qquad ( 22 )$$

where, W_{CCS}^{max} is a maximum quantity of carbon dioxide captured by the CCS, which is equal to carbon emission in a park;
carbon dioxide captured by the CCS is supplied to the P2G device, and a relationship between the power of the CCS and carbon dioxide required by the P2G device is:

$${P}_{CCS}^{i , t} = γ {W}_{CCS}^{i , t} \qquad ( 23 )$$

where, γ is a coefficient of relationship between P_{CCS}^{i,t}, and W_{C0G}^{i,t};
a constraint of the natural gas consumption of the CHP unit is:

$${P}_{load}^{i , t} + {P}_{C C S}^{i , t} + {P}_{P 2 G}^{i , t} = {λ}_{C H P} {V}_{C H P}^{i , t} \qquad ( 24 )$$

where, λ_{CHP} is a coefficient of relationship between the power generation and the natural gas consumption of the CHP unit;
a constraint of gas consumption of a gas boiler is:

$${H}_{G B}^{i , t} = {λ}_{G B} {V}_{G B}^{i , t} \qquad ( 25 )$$

where, λ_{GB} is a coefficient of relationship between the heat generation rate and a natural gas consumption rate of the gas boiler;
a constraint of a total natural gas consumption rate of microgrids is:

$${V}_{i , t} = {V}_{C H P}^{i , t} + {V}_{G B}^{i , t} - {V}_{P 2 G}^{i , t} \qquad ( 26 )$$

where, V_{i,t} is a gas consumption power of the microgrid i at the time t;
an upper and lower boundary constraint of heat production of the boiler is:

$$0 \leq {H}_{G B}^{i , t} \leq {H}_{G B}^{max} \qquad ( 27 )$$

where, H_{GB}^{i,t} is a heat generation rate of the boiler; H_{GB}^{max} is a maximum value of the heat generation rate of the boiler.

Further, the method takes into account a carbon emission and trading model, and the shared energy storage-multi-microgrid system comprises the carbon emission and trading model, and in the carbon emission and trading model:
a CHP unit generates carbon dioxide during operation, a gas boiler discharges carbon dioxide when producing heat, and a CSS is able to reduce direct emission of carbon dioxide; therefore, carbon dioxide emission of microgrids is obtained by subtracting carbon dioxide captured by the CCS from the sum of carbon dioxide generated by the CHP unit and carbon dioxide generated by the gas boiler;

$${W}_{i , t} = δ ( {P}_{load}^{i , t} + {P}_{C C S}^{i , t} + {P}_{P 2 G}^{i , t} + {k}_{1} {H}_{C H P}^{i , t} ) + ε {H}_{G B}^{i , t} - {W}_{C C S}^{i , t} \qquad ( 28 )$$

W_{i,t} is carbon emission of a microgrid i at a time t; δ is a coefficient of relationship between a power generation rate of the CHP unit and carbon dioxide; k₁ is an electrothermal conversion coefficient in case of a minimum power generation rate of the CHP unit; ε is a carbon dioxide emission coefficient of the gas boiler; H_{GB}^{i,t} is a heat generation rate of the boiler;
carbon emission of the comprehensive energy microgrids in one day is:

$${W}_{i} = {{\sum }_{t ∈ 1}}^{24} {W}_{i , t} \qquad ( 29 )$$

Wᵢ is carbon emission of the comprehensive energy microgrid i in one day;
carbon trading is an economic means for reducing carbon emission based on trading of carbon emission permits by defining carbon credits; a carbon quota, also referred to the carbon emission permit, is the quantity of carbon dioxide permitted to be discharged; the carbon quota of the microgrids is:

$${W}_{i , allo} = η {\sum }_{t = 1}^{24} {P}_{load}^{i , t} + {P}_{C C S}^{i , t} + {P}_{P 2 G}^{i , t} + {H}_{G B}^{i , t} \qquad ( 30 )$$

where, W_{i,allo} is the carbon quota previously allocated to the microgrid i; η is a carbon quota allocation parameter;
a relationship between the carbon emission, the carbon quota and the carbon trading is:

$${W}_{i} - {W}_{i , allo} = {W}_{i , 0} + {\sum }_{j = 1}^{j = N} {W}_{b u y}^{i , j} \qquad ( 31 )$$

$${W}_{i , 0} \leq 0 \qquad ( 32 )$$

where, Wᵢ is the carbon emission of the microgrid i; W_{i,allo} is the carbon quota of the microgrid i, W_{i,0} is a carbon quota for sale of the microgrid i; W_{buy}^{i,j} is a carbon quota bought by the microgrid i within an interval j,
heat of the microgrids is from a CHP system and the gas boiler, and a heat power balance constraint of the microgrids is:

$${H}_{C H P}^{i , t} + {H}_{G B}^{i , t} = H l o a {d}_{adjust}^{i , t} \qquad ( 33 )$$

where, H_{CHP}^{i,t} is a heat generation rate of the CHP unit; H_{GB}^{i,t} generation rate of the boiler; Hload_{adjust}^{i,t} is a heat load power after a demand response;
constraints of the quantity of power bought from and sold to shared energy storage (SES) by the microgrids are:

$$0 \leq {P}_{{sell}_{t o s}}^{i , t} \leq {P}_{{sell}_{t o s}}^{max} * flag \qquad ( 34 )$$

$$0 \leq {P}_{b u {y}_{fS}}^{i , t} \leq {P}_{b u {y}_{fS}}^{max} * ( 1 - flag ) \qquad ( 35 )$$

where, p_{sell_toS}^{i,t} is a selling power between the microgrid i and the SES at the time t; P_{buy_fS}^{i,t} pit is a buying power between the microgrid i and the SES at the time t; P_{sell_toS}^{max} is a maximum selling power between the microgrids and the SES; P_{buy_fS}^{max} is a maximum buying power between the microgrids and the SES; flag is a power buying/selling flag, which is 0 or 1; when flag is 0, only power buying is allowed; when flag is 1, only power selling is allowed; in this way, only power selling or power buying is allowed at a same time.

Further, the cost model of microgrids in the shared energy storage-multi-microgrid system comprises a power/gas buying cost of the microgrids, a demand response cost of the microgrids, a carbon trading cost and an operating cost of CHP units in the microgrids:
the power/gas buying cost of the microgrids is:

$${C}_{b u y}^{i} = {\sum }_{t = 1}^{t = 24} {P}_{b u {y}_{fS}}^{i , t} * {γ}_{{e}_{buy}}^{i , t} - {P}_{s e l {l}_{t o G}}^{i , t} * {γ}_{{e}_{s e l l}}^{i , t} + {\sum }_{t = 1}^{t = 24} {V}_{i , t} * {γ}_{G a s} \qquad ( 36 )$$

where, C_{buy}ⁱ is the power/gas buying cost of a microgrid i; γ_{e_buy}^{i,t} is a price at which the microgrid i buys power from shared energy storage at a time t; γ_{e_sell}^{i,t} is a price at which the microgrid i sells power to the shared energy storage at the time t; γ_{Gas} is a price of natural gas;
the demand response cost of the microgrids is:

$${C}_{Dr}^{i} = {C}_{1} {\sum }_{t = 1}^{T} E l o a {d}_{c u t}^{i , t} + {C}_{2} {\sum }_{t = 1}^{T} \vert {Eload}_{transfer}^{i , t} \vert + {C}_{3} {\sum }_{t = 1}^{T} H l o a {d}_{c u t}^{i , t} \qquad ( 37 )$$

where, C_{Dr}ⁱ is the demand response cost of the microgrid i, C₁ is a cost coefficient of power load reduction of the microgrid i at the time t, C₃ is a cost coefficient of heat load reduction of the microgrid i at the time t;
the carbon trading cost is:

$${C}_{carbon}^{i} = {W}_{i , 0} * {γ}_{{sell}_{carbon}} + {\sum }_{j = 1}^{N} {γ}_{{buy}_{carbon}}^{j} {W}_{buy}^{i , j} \qquad ( 38 )$$

where, C_{carbon}ⁱ is the carbon trading cost of the microgrid i; γ_{sell_carbon} is a carbon quota selling price; γ_{buy_carbon}^{j} is a carbon quota buying price at a time j, N is a maximum interval number of carbon trading intervals;
the operating cost of the CHP units in the microgrids is:

$${C}_{CHP}^{i} = {\sum }_{t = 1}^{T} {a}_{1} ( {P}_{load}^{i , t} + {P}_{CCS}^{i , t} + {P}_{P 2 G}^{i , t} ) + {\sum }_{t = 1}^{T} {a}_{2} {P}_{CCS}^{i , t} + {\sum }_{t = 1}^{T} {a}_{3} {P}_{P 2 G}^{i , t} \qquad ( 39 )$$

where, C_{CHP}ⁱ is the operating cost of the CHP unit in the microgrid i, α₁ is a power generation cost coefficient of the microgrid i at the time t; α₂ is an operating cost coefficient of a CCS; α₃ is an operating cost coefficient of a P2G device;
the cost model of the microgrids is:

$${C}_{i} = {C}_{buy}^{i} + {C}_{Dr}^{i} + {C}_{carbon}^{i} + {C}_{CHP}^{i} \qquad ( 40 )$$

where, Cᵢ is a cost of the microgrid i;
an objective function of the cost model is:

$$min {\sum }_{i} {C}_{i} \qquad ( 41 )$$

an optimal value of the objective function under the constraints is resolved by a MILP algorithm.

In the other aspect, the application provides a shared energy storage system optimization system for comprehensive energy microgrids, comprising:
a model construction unit configured to store the cost model and constraints of the shared energy storage-multi-microgrid system in the shared energy storage system optimization method for comprehensive energy microgrids;
a calculation unit configured to resolve an optimal value of the cost model by a MILP algorithm; and
a control unit configured to control devices in the shared energy storage-multi-microgrid system according to the optimal value obtained by the calculation unit.

To sum up, the application has the following beneficial effects: the cost model of the shared energy storage-multi-microgrid system taking into account third-party investment is established, and a minimum operating cost of microgrids is obtained by resolving optimal values of variables in the cost model, thus reducing the operating cost of the microgrids.

### BRIEF DESCRIPTION OF THE SEVERAL VIEWS OF THE DRAWINGS

FIG. 1 illustrates an architecture of a shared energy storage-multi-microgrid system involved in the invention. Shared energy storage is invested by a third party, multiple microgrids are connected to the shared energy storage. The microgrid is a CHP microgrid based on power-heat-gas multi-energy cooperation, and a gas turbine set burns natural gas to supply power and heat to the whole microgrid. In addition, a gas boiler can burn gas to supply heat. Different from traditional CHP unit models, a CCS and a P2G device are introduced into the microgrid to reduce carbon dioxide generated by gas burning. The CCS can capture carbon dioxide generated by a gas boiler and a gas turbine and transmits the captured carbon dioxide to a P2G system, and the P2G system converts the carbon dioxide into natural gas. The model realizes two levels of energy sharing. In addition to power sharing between the shared energy storage and multiple microgrids, and a power sharing model of P2P is established between the microgrids.

FIG. 2 illustrates a CHP model combining CCS and P2G involved in the invention. CHP is regarded as an important alternative of traditional energy systems and has remarkable energy saving and environmental protection effects. CCS can capture and treat carbon dioxide produced by industry and transport the carbon dioxide to a place for long-term storage. P2G can convert power inconvenient to store in the system into methane. As shown, a CHP unit uses natural gas to generate power to satisfy demand of loads in microgrids and supply power to the P2G system and the CCS. The CCS captures carbon dioxide generated by the CHP unit, transmits the captured carbon dioxide to the P2G system. The P2G system produces methane by means of power generated by the CHP unit and the carbon dioxide captured by the CCS.

### DETAILED DESCRIPTION OF THE INVENTION

Specific implementations of the application will be described in detail below in conjunction with accompanying drawings.

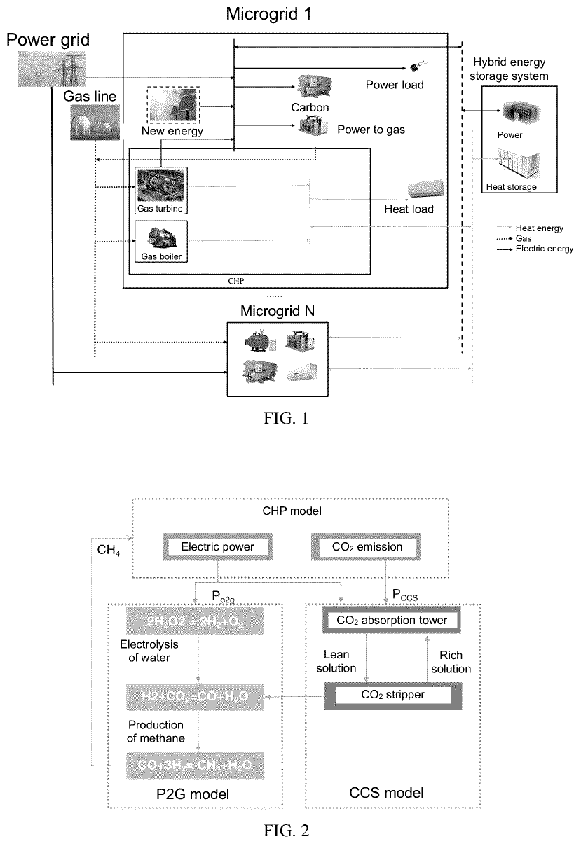

Embodiment: Referring to FIG. 1-FIG. 2, a shared energy storage system optimization method for comprehensive energy microgrids comprises the following steps:
constructing a cost model of a shared energy storage-multi-microgrid system taking into account third-party investment, and setting constraints; and
resolving optimal values of variables in the cost model, and controlling devices in the shared energy storage-multi-microgrid system according to the optimal values.

Comprehensive energy microgrids in the application are regional energy systems integrating multiple energy resources and adjustable loads. Generally, the comprehensive energy microgrid comprises CHP, heat storage, power storage, distributed renewable energy (photovoltaic power and wind power), and the like. A power supply system provides multiple energy sources such as power and heat to satisfy demand of various loads in a park. Because both power and heat are provided by CHP units, a heat supply network and a power supply network are coupled. Wherein, shared energy storage is invested by a third party, and multiple microgrids are connected to the shared energy storage.

The constraints of the shared energy storage-multi-microgrid system comprise:
in order to limit power prices, including a minimum power price, a maximum power price and an average power price, set by a shared energy storage supplier, as a power price publisher, to prevent the power prices from being too high, a boundary constraint of a power buying price:

$${γ}_{{e}_{buy}}^{min} \leq {γ}_{{e}_{buy}}^{i , t} \leq {γ}_{{e}_{buy}}^{max} \qquad ( 1 )$$

where, γ_{e_buy}^{i,t} is a power buying price at which a microgrid i buys power from shared energy storage; γ_{e_buy}^{min} is a minimum value of the power buying price; γ_{e_buy}^{max} is a maximum value of the power buying price;
a boundary constraint of a power selling price:

$${γ}_{{e}_{sell}}^{min} \leq {γ}_{{e}_{sell}}^{i , t} \leq {γ}_{{e}_{sell}}^{max} \qquad ( 2 )$$

where, γ_{e_sell}^{i,t} is a power selling price at which the microgrid i sells power to the shared energy storage; γ_{e_sell}^{min} is a minimum value of the power selling price; γ_{e_sell}^{max} is a maximum value of the power selling price;
constraints of an average power buying/selling price:

$$\frac{{\sum }_{t = 1}^{24} {γ}_{{e}_{buy}}^{i , t}}{24} \leq {γ}_{{e}_{buy}}^{ave \_ max} \qquad ( 3 )$$

$$\frac{{\sum }_{t = 1}^{24} {γ}_{{e}_{sell}}^{i , t}}{24} \leq {γ}_{{e}_{sell}}^{ave \_ max} \qquad ( 4 )$$

where, γ_{e_buy}^{ave_max} is an upper limit of an average price at which the microgrid i buys power from the shared energy storage; γ_{e_sell}^{ave_max} is an upper limit of an average price at which the microgrid i sells power to the shared energy storage;
energy balance constraints of the shared energy storage:

$${E}_{SES}^{1} = {E}_{SES}^{0} + {μ}_{{s}_{charge}} {P}_{{s}_{charge}}^{t} - \frac{{P}_{{s}_{discharge}}^{t}}{{μ}_{{s}_{discharge}}} \qquad ( 5 )$$

$${E}_{SES}^{t} = {E}_{SES}^{t} + {μ}_{{s}_{charge}} {P}_{{s}_{charge}}^{t} - \frac{{P}_{{s}_{discharge}}^{t}}{{μ}_{{s}_{discharge}}} \qquad ( 6 )$$

where, E_{SES}¹ is a power quantity of the shared energy storage at a time t=1; E_{SES}⁰ is an initial energy value of the shared energy storage; μ_{s_charge} is charge efficiency of the shared energy storage; P_{s_charge}^{t} is a charge power of the shared energy storage; P_{s_discharge}^{t} is a discharge power of the shared energy storage; μ_{s_discharge} is discharge efficiency of the shared energy storage;
an upper and lower boundary constraint of energy of the shared energy storage:

$${E}_{SES}^{min} \leq {E}_{SES}^{t} \leq {E}_{SES}^{max} \qquad ( 7 )$$

where, E_{SES}^{t} is an energy value of the shared energy storage at the time t; E_{SES}^{min} is a minimum energy value of the shared energy storage; E_{SES}^{max} is a maximum energy value of the shared energy storage;
constraints of the charge power and the discharge power:

$$0 \leq {P}_{{s}_{charge}}^{t} \leq {S}_{flag} * {P}_{{s}_{charge}}^{max} \qquad ( 8 )$$

$$0 \leq {P}_{{s}_{discharge}}^{t} \leq ( 1 - {S}_{flag} ) * {P}_{{s}_{discharge}}^{max} \qquad ( 9 )$$

where, S_{flag} is a charge and discharge flag of the shared energy storage, which is a variable from 0 to 1 and is configured to define that only charge/discharge is allowed within a same time; p_{s_charge}^{max} is a maximum charge power of the shared energy storage; P_{s_discharge}^{max} is a maximum discharge power of the shared energy storage;
a power balance constraint of the shared energy storage:

$${P}_{{s}_{charge}}^{t} - {P}_{{s}_{dischage}}^{t} = {P}_{{s}_{{buy}_{fG}}}^{t} - {P}_{{s}_{{sell}_{toG}}}^{t} + {\sum }_{i = 1}^{U} {P}_{{buy}_{fS}}^{i , t} - {\sum }_{i = 1}^{U} {P}_{{sell}_{toS}}^{i , t} \qquad ( 10 )$$

where, P_{s_buy_fG}^{t} is a buying power at which the shared energy storage buys power from a power grid of, P_{s_sell_toG}^{t} is a selling power at which the shared energy storage sells power to the power grid; P_{buy}_{_{fS}}^{i,t} is an electric power bought by the microgrid i from the shared energy storage by; P_{selltoS}^{i,t} is an electric power sold by the microgrid i to the shared energy storage; U is a total number of microgrids trading with the shared energy storage;
constraints for the shared energy storage to buy and sell power to a main power grid:

$$0 \leq {P}_{{s}_{{buy}_{fG}}}^{t} \leq {P}_{{s}_{{buy}_{fG}}}^{max} \qquad ( 11 )$$

$$0 \leq {P}_{{s}_{{sell}_{toG}}}^{t} \leq {P}_{{s}_{{sell}_{toG}}}^{max} \qquad ( 12 )$$

where, P_{s_buy_fG}^{max} is a maximum power at which the shared energy storage buys power from the power grid; P_{s_sell_toG}^{max} is a maximum power at which the shared energy storage sells power to the power grid.

The method takes into account a CHP model combining CCS and P2G. CHP is regarded as an important alternative of traditional energy systems and has remarkable energy saving and environmental protection effects. One fuel is used for producing heat and power at the same time, which compared with separate production of heat and power, the efficiency is higher, and the cost is further reduced. HCP can improve energy efficiency and reduce carbon emission and energy costs.

Wherein, CCS can capture and treat carbon dioxide produced by industry and transport the carbon dioxide to a place for long-term storage. P2G is used for converting power inconvenient to store in the system into methane. Generally, carbon dioxide is captured in power plants, chemical plants or places where a large quantity of fossil fuel is used, and is then stored on the seabed or deep geologic structures.

P2G can convert power inconvenient to store in the system into methane, which is easy to transport and store and can be used as energy input of the system to realize energy recycling. P2G mainly includes two steps: producing hydrogen by electrolysis of water; and synthesizing methane by means of the produced hydrogen and carbon dioxide. In the aspect of materials required for P2G, the technique can reduce the emission of carbon dioxide.

The shared energy storage-multi-microgrid system comprises the CHP model, and in the CHP model:
a gas turbine set burns natural gas to generate power, and for a microgrid i at a time t, a power generation model of the gas turbine set is:

$${P}_{CHP}^{i , t} = {V}_{CHP}^{i , t} η Q \qquad ( 13 )$$

where, P_{CHP}^{i,t} is a power generation rate of the microgrid i at the time t; V_{CHP}^{i,t} is natural gas consumption, and η is power generation efficiency of the gas turbine set; Q is a heat value of the natural gas;
because of the characteristic of fixing power based on heat of the gas turbine set, an electrothermal coupling constraint is:

$$max \{ {P}_{CHP}^{min} - {k}_{1} {H}_{CHP}^{i , t} , m ( {H}_{CHP}^{i , t} - {H}_{i , 0} ) \} \leq {P}_{CHP}^{i , t} \leq {P}_{CHP}^{max} - {k}_{2} {H}_{CHP}^{i , t} \qquad ( 14 )$$

where, P_{CHP}^{min} is a minimum power generation rate of a CHP unit; P_{CHP}^{max} is a maximum power generation rate of the CHP unit; H_{CHP}^{i,t} is a heat generation rate of the CHP unit; k₁ is an electrothermal conversion coefficient in case of the minimum power generation rate of the CHP unit; k₂ is an electrothermal conversion coefficient in case of the maximum power generation rate of the CHP unit; m is a linear supply slope of a thermoelectric power of CHP; H_{i,0} is a heat power in case of the minimum power generation rate of the CHP unit;
in the CHP system comprising a CCS and a P2G device, power generated by CHP is used for satisfying demand of conventional power loads, satisfying power demand of the CCS, and satisfying power demand of the P2G device, which is expressed as:

$${P}_{CHP}^{i , t} = {P}_{load}^{i , t} + {P}_{CCS}^{i , t} + {P}_{P 2 G}^{i , t} \qquad ( 15 )$$

where, P_{CHP}^{i,t} is a power generation rate of the CHP unit; put is a power supply rate of the CHP unit, which is used for satisfying the demand of the conventional power loads in the microgrids; P_{CCS}^{i,t} is a power consumption rate of the CCS; P_{P2G}^{i,t} is a power consumption rate of the P2G; the CCS captures carbon dioxide generated by the CHP system and transmits the captured carbon dioxide to the P2G device; the CCS reduces the quantity of carbon dioxide generated by the CHP system, and the P2G device is able to convert the captured carbon dioxide into natural gas which is used by the CHP system;
a constraint of the power supply rate of the CHP unit is:

$${P}_{load}^{min} \leq {P}_{load}^{i , t} \leq {P}_{load}^{max} \qquad ( 16 )$$

where, p_{load}^{min} is a minimum value of the power supply rate of the CHP unit; p_{load}^{max} is a maximum value of the power supply rate of the CHP unit;
a ramp constraint of the CHP unit is:

$${P}_{ramp}^{min} \leq ( {P}_{load}^{i , t} + {P}_{CCS}^{i , t} + {P}_{P 2 G}^{i , t} ) - ( {P}_{load}^{i , t - 1} + {P}_{CCS}^{i , t - 1} + {P}_{P 2 G}^{i , t - 1} ) \leq {P}_{ramp}^{max} \qquad ( 17 )$$

where, Pᵣₐᵢₙ^{min} is a minimum value of a power ramp of the CHP unit; Pᵣₐₘₚ^{max} is a maximum value of the power ramp of the CHP unit; (P_{load}^{i,t}+P_{CCS}^{i,t}+P_{P2G}^{i,t})−(p_{load}^{i,t-1}+p_{CCS}^{i,t-1}+P_{P2G}^{i,t-1}) is the power ramp of the CHP unit;
a power range constraint of the CCS is:

$${P}_{CCS}^{min} \leq {P}_{CCS}^{i , t} \leq {P}_{CCS}^{max} \qquad ( 18 )$$

where, P_{CCS}^{min} is a minimum operating power of the CCS; P_{CCS}^{max} is a maximum operating power of the CCS;
a power range constraint of the P2G device is:

$${P}_{P 2 G}^{min} \leq {P}_{P 2 G}^{i , t} \leq {P}_{P 2 G}^{max} \qquad ( 19 )$$

where, p_{P2G}^{min} is a minimum operating power of the P2G device; P_{P2G}^{max} maximum operating power of the P2G device;
a power at which the P2G device to generate natural gas by means of hydrogen and carbon dioxide by consuming power is:

$${V}_{P 2 G}^{i , t} = α {P}_{P 2 G}^{i , t} \qquad ( 20 )$$

where, V_{P2G}^{i,t}, is a gas generation power of the P2G device; α is a power-to-gas efficiency coefficient; p_{P2G}^{i,t} is a power of the P2G device;
the quantity of carbon dioxide acquired by the P2G device from CCS to generate natural gas under a certain power of the P2G device is:

$${W}_{CCS}^{i , t} = β {P}_{P 2 G}^{i , t} \qquad ( 21 )$$

where, W_{ccs}^{i,t} is the quantity of carbon dioxide required by the P2G device under the power P_{P2G}^{i,t}; β is a coefficient of relationship between W_{CCS}^{i,t} and P_{P2G}^{i,t};
a range constraint of the quantity of captured carbon dioxide is:

$$0 \leq {W}_{CCS}^{i , t} \leq {W}_{CCS}^{max} \qquad ( 22 )$$

where, W_{CCS}^{max} is a maximum quantity of carbon dioxide captured by the CCS, which is equal to carbon emission in a park;
carbon dioxide captured by the CCS is supplied to the P2G device, and a relationship between the power of the CCS and carbon dioxide required by the P2G device is:

$${P}_{CCS}^{i , t} = γ {W}_{CCS}^{i , t} \qquad ( 23 )$$

where, γ is a coefficient of relationship between P_{CCS}^{i,t} and W_{C02}^{i,t};

In the application, main energy consumption of the microgrids is natural gas. Natural gas is converted into power/heat by CHP and GB, and carbon dioxide captured by CCS is converted into natural gas by P2G.
a constraint of the natural gas consumption of the CHP unit is:

$${P}_{load}^{i , t} + {P}_{CCS}^{i , t} + {P}_{P 2 G}^{i , t} = {λ}_{CHP} {V}_{CHP}^{i , t} \qquad ( 24 )$$

where, λ_{CHP} is a coefficient of relationship between the power generation and the natural gas consumption of the CHP unit;
a constraint of gas consumption of a gas boiler is:

$${H}_{GB}^{i , t} = {λ}_{GB} {V}_{GB}^{i , t} \qquad ( 25 )$$

where, λ_{GB} is a coefficient of relationship between the heat generation rate and a natural gas consumption rate of the gas boiler;
a constraint of a total natural gas consumption rate of microgrids is:

$${V}_{i , t} = {V}_{CHP}^{i , t} + {V}_{GB}^{i , t} - {V}_{P 2 G}^{i , t} \qquad ( 26 )$$

where, V_{i,t} is a gas consumption power of the microgrid i at the time t;
an upper and lower boundary constraint of heat production of the boiler is:

$$0 \leq {H}_{GB}^{i , t} \leq {H}_{G B}^{max} \qquad ( 27 )$$

where, H_{GB}^{i,t} is a heat generation rate of the boiler; H_{GB}^{max} is a maximum value of the heat generation rate of the boiler.

The method takes into account a carbon emission and trading model, and the shared energy storage-multi-microgrid system comprises the carbon emission and trading model, and in the carbon emission and trading model:
a CHP unit generates carbon dioxide during operation, a gas boiler discharges carbon dioxide when producing heat, and a CSS is able to reduce direct emission of carbon dioxide; therefore, carbon dioxide emission of microgrids is obtained by subtracting carbon dioxide captured by the CCS from the sum of carbon dioxide generated by the CHP unit and carbon dioxide generated by the gas boiler;

$${W}_{i , t} = δ ( {P}_{load}^{i , t} + {P}_{CCS}^{i , t} + {P}_{P 2 G}^{i , t} + {k}_{1} {H}_{CHP}^{i , t} ) + ε {H}_{GB}^{i , t} - {W}_{CCS}^{i , t} \qquad ( 28 )$$

W_{i,t} is carbon emission of a microgrid i at a time t; δ is a coefficient of relationship between a power generation rate of the CHP unit and carbon dioxide; k₁ is an electrothermal conversion coefficient in case of a minimum power generation rate of the CHP unit; ε is a carbon dioxide emission coefficient of the gas boiler; H_{GB}^{i,t} is a heat generation rate of the boiler;
carbon emission of the comprehensive energy microgrids in one day is:

$${W}_{i} = {{\sum }^{24}}_{t ∈ 1} {W}_{i , t} \qquad ( 29 )$$

Wᵢ is carbon emission of the comprehensive energy microgrid i in one day;
carbon trading is an economic means for reducing carbon emission based on trading of carbon emission permits by defining carbon credits; a carbon quota, also referred to the carbon emission permit, is the quantity of carbon dioxide permitted to be discharged; the carbon quota of the microgrids is:

$${W}_{i , allo} = η {\sum }_{t = 1}^{24} {P}_{load}^{i , t} + {P}_{CCS}^{i , t} + {P}_{P 2 G}^{i , t} + {H}_{GB}^{i , t} \qquad ( 30 )$$

where, W_{i,allo} is the carbon quota previously allocated to the microgrid i; η is a carbon quota allocation parameter;
a relationship between the carbon emission, the carbon quota and the carbon trading is:

$${W}_{i} - {W}_{i , allo} = {W}_{i , 0} + {\sum }_{j = 1}^{j = N} {W}_{b u y}^{i , j} \qquad ( 31 )$$

$${W}_{i , 0} \leq 0 \qquad ( 32 )$$

where, Wᵢ is the carbon emission of the microgrid i; W_{i,allo} is the carbon quota of the microgrid i; W_{i,0} is a carbon quota for sale of the microgrid i; W_{buy}^{i,j} is a carbon quota bought by the microgrid i within an interval j;
heat of the microgrids is from a CHP system and the gas boiler, and a heat power balance constraint of the microgrids is:

$${H}_{C H P}^{i , t} + {H}_{G B}^{i , t} = Hloa {d}_{adjust}^{i , t} \qquad ( 33 )$$

where, H_{CHP}^{i,t} is a heat generation rate of the CHP unit; H_{GB}^{i,t} is a heat generation rate of the boiler; Hload_{adjust}^{i,t} is a heat load power after a demand response;
constraints of the quantity of power bought from and sold to shared energy storage (SES) by the microgrids are:

$$0 \leq {P}_{{sell}_{t o s}}^{i , t} \leq {P}_{{sell}_{t o s}}^{max} * flag \qquad ( 34 )$$

$$0 \leq {P}_{{buy}_{fS}}^{i , t} \leq {P}_{{buy}_{fS}}^{max} * ( 1 - flag ) \qquad ( 35 )$$

where P_{sell_toS}^{i,t} is a selling power between the microgrid i and the SES at the where, pit time t; P_{buy_fS}^{i,t} is a buying power between the microgrid i and the SES at the time t; P_{sell_toS}^{max} is a maximum selling power between the microgrids and the SES; P_{buy_fS}^{max} is a maximum buying power between the microgrids and the SES; flag is a power buying/selling flag, which is 0 or 1; when flag is 0, only power buying is allowed; when flag is 1, only power selling is allowed; in this way, only power selling or power buying is allowed at a same time.

The cost model of microgrids in the shared energy storage-multi-microgrid system comprises a power/gas buying cost of the microgrids, a demand response cost of the microgrids, a carbon trading cost and an operating cost of CHP units in the microgrids:
the power/gas buying cost of the microgrids is:

$${C}_{b u y}^{i} = {\sum }_{t = 1}^{t = 24} {P}_{b u {y}_{fS}}^{i , t} * {γ}_{{e}_{buy}}^{i , t} - {P}_{s e l {l}_{t o G}}^{i , t} * {γ}_{{e}_{s e l l}}^{i , t} + {\sum }_{t = 1}^{t = 24} {V}_{i , t} * {γ}_{G a s} \qquad ( 36 )$$

where, C_{buy}ⁱ is the power/gas buying cost of a microgrid i; γ_{e_buy}^{i,t} is a price at which the microgrid i buys power from shared energy storage at a time t; γ_{e_sell}^{i,t} is a price at which the microgrid i sells power to the shared energy storage at the time t; γ_{Gas} is a price of natural gas;
the demand response cost of the microgrids is:

$${C}_{Dr}^{i} = {C}_{1} {\sum }_{t = 1}^{T} Eloa {d}_{c u t}^{i , t} + {C}_{2} {\sum }_{t = 1}^{T} \vert {Eload}_{transfer}^{i , t} \vert + {C}_{3} {\sum }_{t = 1}^{T} Hloa {d}_{c u t}^{i , t} \qquad ( 37 )$$

where, C_{Dr}ⁱ is the demand response cost of the microgrid i; C₁ is a cost coefficient of power load reduction of the microgrid i at the time t; C₃ is a cost coefficient of heat load reduction of the microgrid i at the time t;
the carbon trading cost is:

$${C}_{c a r b o n}^{i} = {W}_{i , 0} * {γ}_{s e l {l}_{c a r b o n}} + {\sum }_{j = 1}^{N} {γ}_{b u {y}_{c a r b o n}}^{j} {W}_{b u y}^{i , j} \qquad ( 38 )$$

where, C_{carbon}ⁱ is the carbon trading cost of the microgrid i; γ_{sell_carbon} is a carbon quota selling price; γ_{buy_carbon}^{j} is a carbon quota buying price at a time j; N is a maximum interval number of carbon trading intervals;
the operating cost of the CHP units in the microgrids is:

$${C}_{C H P}^{i} = {\sum }_{t = 1}^{T} {a}_{1} ( {P}_{load}^{i , t} + {P}_{C C S}^{i , t} + {P}_{P 2 G}^{i , t} ) + {\sum }_{t = 1}^{T} {a}_{2} {P}_{C C S}^{i , t} + {\sum }_{t = 1}^{T} {a}_{3} {P}_{P 2 G}^{i , t} \qquad ( 39 )$$

where, C_{CHP}ⁱ is the operating cost of the CHP unit in the microgrid i; α₁ is a power generation cost coefficient of the microgrid i at the time t; α₂ is an operating cost coefficient of a CCS; α₃ is an operating cost coefficient of a P2G device;
the cost model of the microgrids is:

$${C}_{i} = {C}_{b u y}^{i} + {C}_{Dr}^{i} + {C}_{carbon}^{i} + {C}_{C H P}^{i} \qquad ( 40 )$$

where, Cᵢ is a cost of the microgrid i; to ensure economical and efficient operation of the microgrids, a MILP algorithm is adopted in the application to minimize the cost of the microgrids.

An objective function of the cost model is:

$$min {\sum }_{i} {C}_{i} \qquad ( 41 )$$

An optimal value of the objective function under the constraints is resolved by the MILP algorithm. The objective function aims to find an optimal scheduling strategy to minimize the total cost of the whole microgrid system so as to provide powerful support for sustainable operation of the microgrids.

In other implementations, a shared energy storage system optimization system for comprehensive energy microgrids is provided, comprising:
a model construction unit configured to store the cost model and constraints of the shared energy storage-multi-microgrid system in the shared energy storage system optimization method for comprehensive energy microgrids;
a calculation unit configured to resolve an optimal value of the cost model by a MILP algorithm; and
a control unit configured to control devices in the shared energy storage-multi-microgrid system according to the optimal value obtained by the calculation unit.

The comprehensive energy microgrid system model in the application integrates multiple energy sources and controllable loads and uses carbon capture and P2G. Main points and implementations of the model are summarized below:

Comprehensive energy microgrid system: the microgrid system integrates multiple energy sources, including CHP, heat storage, power storage, and distributed renewable energy (photovoltaic power and wind power) to satisfy demand of different loads.

Shared energy storage: the shared energy storage may be invested by a third party and serve as a power price publisher, and the power price published by the shared energy storage is limited by the minimum power price, the maximum power price and the average power price to ensure that the power price is reasonable.

Energy balance constraint: energy balance of the shared energy storage is constrained by charge and discharge efficiency, energy state, and upper and lower boundaries of energy to keep power in balance.

CHP system: CHP is used for producing heat and power at the same time to improve energy efficiency and reduce carbon emission and costs.

Carbon capture and power to gas: carbon capture and power to gas are used for capturing, storing and recycling carbon dioxide to reduce carbon emission to improve the environmental friendliness of the system.

Carbon trading model: the microgrid controls carbon emission by carbon trading to limit the carbon emission quota and realize economical management of carbon emission by buying and selling carbon emission permits.

Cost model of microgrids: costs of the microgrids include a power/gas buying cost, a demand response cost, a carbon trading cost and an operating cost of CHP units, and the scheduling objective is to minimize of these costs.

By means of the model, energy interaction and flowing of the microgrids can be described more accurately, thus providing a theoretical basis for optimal operation of the microgrids.

To realize economical operation of the microgrids, the objective function for minimizing the total cost, including the power/gas buying cost, the demand response cost, the carbon trading cost and the operating cost of CHP units of the microgrids is proposed. A series of optimal solutions can be obtained by resolving the objective function, and these solutions describe how to adjust various parameters in the microgrids under different operating conditions to minimize the cost.

Specifically, by resolving the objective function for minimizing the cost of microgrids, optimal values of the following parameter variables can be obtained:
1. Power buying and selling price of shared energy storage.
2. Power loads and heat loads of the microgrids.
3. Buying and selling price of carbon trading.
4. Operating strategies of the CHP units, including operating strategies of power generation, CCS and P2G.

By adjusting these parameter variables, economical operation of the microgrids can be realized, stable and reliable operation of the microgrids can be ensured, thus providing powerful support for actual application of the microgrids.

To sum up, the comprehensive energy microgrid system model combines various energy techniques and carbon management strategies to improve energy efficiency, reduce carbon emission and minimize the total cost of the microgrids. Such a system has a great application potential in energy sustainability and environmental production and can provide powerful support for the development of energy systems in the future.

The implementations described above are merely preferred ones of the application. It should be pointed out that those ordinarily skilled in the art can make some transformations and improvements without departing from the inventive concept of the application, and all these transformations and improvements should fall within the protection scope of the application.

What is claimed is:

1. A shared energy storage system optimization method for comprehensive energy microgrids, comprising the following steps:
constructing a cost model of a shared energy storage-multi-microgrid system taking into account third-party investment, and setting constraints; and
resolving optimal values of variables in the cost model, and controlling devices in the shared energy storage-multi-microgrid system according to the optimal values.

2. The shared energy storage system optimization method for comprehensive energy microgrids according to claim 1, wherein the constraints of the shared energy storage-multi-microgrid system comprise:
in order to limit power prices, including a minimum power price, a maximum power price and an average power price, set by a shared energy storage supplier, as a power price publisher, to prevent the power prices from being too high, a boundary constraint of a power buying price:
$${γ}_{{e}_{buy}}^{min} \leq {γ}_{{e}_{buy}}^{i , t} \leq {γ}_{{e}_{buy}}^{max} \qquad ( 1 )$$
where, γ_{e_buy}^{i,t} is a power buying price at which a microgrid i buys power from shared energy storage; γ_{e_buy}^{min} is a minimum value of the power buying price; γ_{e_buy}^{max} buy is a maximum value of the power buying price;
a boundary constraint of a power selling price:
$${γ}_{{e}_{s e l l}}^{min} \leq {γ}_{{e}_{s e l l}}^{i , t} \leq {γ}_{{e}_{s e l l}}^{max} \qquad ( 2 )$$
where, γ_{e_sell}^{i,t} is a power selling price at which the microgrid i sells power to the shared energy storage; γ_{e_sell}^{min} is a minimum value of the power selling price; γ_{e_sell}^{max} is a maximum value of the power selling price;
constraints of an average power buying/selling price:
$$\frac{{\sum }_{t = 1}^{24} {γ}_{{e}_{buy}}^{i , t}}{24} \leq {γ}_{{e}_{buy}}^{ave \_ max} \qquad ( 3 )$$
$$\frac{{\sum }_{t = 1}^{24} {γ}_{{e}_{s e l l}}^{i , t}}{24} \leq {γ}_{{e}_{s e l l}}^{ave \_ max} \qquad ( 4 )$$
where γ_{e_buy}^{ave_max} is an upper limit of an average price at which the microgrid i buys power from the shared energy storage; γ_{e_sell}^{ave_max} is an upper limit of an average price at which the microgrid i sells power to the shared energy storage;
energy balance constraints of the shared energy storage:
$${E}_{S E S}^{1} = {E}_{S E S}^{0} + {μ}_{{s}_{c harge}} {P}_{{s}_{c harge}}^{t} - \frac{{P}_{{s}_{d i s c harge}}^{t}}{{μ}_{{s}_{d i s c harge}}} \qquad ( 5 )$$
$${E}_{S E S}^{t} = {E}_{S E S}^{t} + {μ}_{{s}_{c harge}} {P}_{{s}_{charge}}^{t} - \frac{{P}_{{s}_{d i s c harge}}^{t}}{{μ}_{{s}_{d i s c harge}}} \qquad ( 6 )$$
where, E_{SES}¹ is a power quantity of the shared energy storage at a time t=1; E_{SES}⁰ is an initial energy value of the shared energy storage; μ_{s_charge} is charge efficiency of the shared energy storage; P_{s_charge}^{t} is a charge power of the shared energy storage; P_{s_discharge}^{t} is a discharge power of the shared energy storage; μ_{s_discharge} is discharge efficiency of the shared energy storage;
an upper and lower boundary constraint of energy of the shared energy storage:
$${E}_{S E S}^{min} \leq {E}_{S E S}^{t} \leq {E}_{S E S}^{max} \qquad ( 7 )$$
where, E_{SES}^{t} is an energy value of the shared energy storage at the time t, E_{SES}^{min} is a minimum energy value of the shared energy storage; E_{SES}^{max} is a maximum energy value of the shared energy storage;
constraints of the charge power and the discharge power:
$$0 \leq {P}_{{s}_{c h a r g e}}^{t} \leq {S}_{flag} * {P}_{{s}_{c h a r g e}}^{max} \qquad ( 8 )$$
$$0 \leq {P}_{{s}_{d i s c h a r g e}}^{t} \leq ( 1 - {S}_{flag} ) * {P}_{{s}_{discharge}}^{max} \qquad ( 9 )$$
where, S_{flag} is a charge and discharge flag of the shared energy storage, which is a variable from 0 to 1 and is configured to define that only charge/discharge is allowed within a same time; p_{s_charge}^{max} is a maximum charge power of the shared energy storage; p_{s_discharge}^{max} is a maximum discharge power of the shared energy storage;
a power balance constraint of the shared energy storage:
$${P}_{{s}_{charge}}^{t} - {P}_{{s}_{dischage}}^{t} = {P}_{{s}_{{buy}_{fG}}}^{t} - {P}_{{s}_{{sell}_{toG}}}^{t} + {\sum }_{i = 1}^{U} {P}_{{buy}_{fS}}^{i , t} - {\sum }_{i = 1}^{U} {P}_{{sell}_{toS}}^{i , t} \qquad ( 10 )$$
where, P_{s_buy_fG}^{t} is a buying power at which the shared energy storage buys power from a power grid of; P_{s_sell_toG}^{t} is a selling power at which the shared energy storage sells power to the power grid; p_{buy}_{_{fS}}^{i,t} is an electric power bought by the microgrid i from the shared energy storage by; pₛₑₗₗ_{_{toS}}^{i,t} is an electric power sold by the microgrid i to the shared energy storage; U is a total number of microgrids trading with the shared energy storage;
constraints for the shared energy storage to buy and sell power to a main power grid:
$$0 \leq {P}_{{s}_{{buy}_{fG}}}^{t} \leq {P}_{{s}_{{buy}_{fG}}}^{max} \qquad ( 11 )$$
$$0 \leq {P}_{{s}_{sel {l}_{toG}}}^{t} \leq {P}_{{s}_{{sell}_{toG}}}^{max} \qquad ( 12 )$$
where, p_{s_buy_fG}^{max} is a maximum power at which the shared energy storage buys power from the power grid; p_{s_sell_toG}^{max} is a maximum power at which the shared energy storage sells power to the power grid.

3. The shared energy storage system optimization method for comprehensive energy microgrids according to claim 1, wherein the method takes into account a CHP model combining CCS and P2G, and the shared energy storage-multi-microgrid system comprises the CHP model, and in the CHP model:
a gas turbine set burns natural gas to generate power, and for a microgrid i at a time t, a power generation model of the gas turbine set is:
$${P}_{CHP}^{i , t} = {V}_{CHP}^{i , t} η Q \qquad ( 13 )$$
where, P_{CHP}^{i,t} is a power generation rate of the microgrid i at the time t; V_{CHP}^{i,t} is natural gas consumption, and η is power generation efficiency of the gas turbine set; Q is a heat value of the natural gas;
because of the characteristic of fixing power based on heat of the gas turbine set, an electrothermal coupling constraint is:
$$max \{ {P}_{CHP}^{min} - {k}_{1} {H}_{CHP}^{i , t} , m ( {H}_{CHP}^{i , t} - {H}_{i , 0} ) \} \leq {P}_{CHP}^{i , t} \leq {P}_{CHP}^{max} - {k}_{2} {H}_{CHP}^{i , t} \qquad ( 14 )$$
where, P_{CHP}^{min} is a minimum power generation rate of a CHP unit; P_{CHP}^{max} is a maximum power generation rate of the CHP unit; H_{CHP}^{i,t} is a heat generation rate of the CHP unit; k₁ is an electrothermal conversion coefficient in case of the minimum power generation rate of the CHP unit; k₂ is an electrothermal conversion coefficient in case of the maximum power generation rate of the CHP unit; m is a linear supply slope of a thermoelectric power of CHP; H_{i,0} is a heat power in case of the minimum power generation rate of the CHP unit;
in the CHP system comprising a CCS and a P2G device, power generated by CHP is used for satisfying demand of conventional power loads, satisfying power demand of the CCS, and satisfying power demand of the P2G device, which is expressed as:
$${P}_{CHP}^{i , t} = {P}_{load}^{i , t} + {P}_{CCS}^{i , t} + {P}_{P 2 G}^{i , t} \qquad ( 15 )$$
where, P_{CHP}^{i,t} is a power generation rate of the CHP unit; P_{load}^{i,t} is a power supply rate of the CHP unit, which is used for satisfying the demand of the conventional power loads in the microgrids; P_{CCS}^{i,t} is a power consumption rate of the CCS; P_{P2G}^{i,t} is a power consumption rate of the P2G; the CCS captures carbon dioxide generated by the CHP system and transmits the captured carbon dioxide to the P2G device; the CCS reduces the quantity of carbon dioxide generated by the CHP system, and the P2G device is able to convert the captured carbon dioxide into natural gas which is used by the CHP system;
a constraint of the power supply rate of the CHP unit is:
$${P}_{load}^{min} \leq {P}_{load}^{i , t} \leq {P}_{load}^{max} \qquad ( 16 )$$
where, P_{load}^{min} is a minimum value of the power supply rate of the CHP unit; P_{load}^{max} is a maximum value of the power supply rate of the CHP unit;
a ramp constraint of the CHP unit is:
$${P}_{ramp}^{min} \leq ( {P}_{load}^{i , t} + {P}_{CCS}^{i , t} + {P}_{P 2 G}^{i , t} ) - ( {P}_{load}^{i , t - 1} + {P}_{CCS}^{i , t - 1} + {P}_{P 2 G}^{i , t - 1} ) \leq {P}_{ramp}^{max} \qquad ( 17 )$$
where, Pᵣₐₘₚ^{min} is a minimum value of a power ramp of the CHP unit; Pᵣₐₘₚ^{max} is a maximum value of the power ramp of the CHP unit; (P_{load}^{i,t}+p_{CCS}^{i,t}+p_{P2G}^{i,t})−(p_{load}^{i,t-1}+P_{CCS}^{i,t-1}+p_{P2G}^{i,t-1}) is the power ramp of the CHP unit;
a power range constraint of the CCS is:
$${P}_{CCS}^{min} \leq {P}_{CCS}^{i , t} \leq {P}_{CCS}^{max} \qquad ( 18 )$$
where, P_{CCS}^{min} is a minimum operating power of the CCS; P_{CCS}^{max} is a maximum operating power of the CCS;
a power range constraint of the P2G device is:
$${P}_{P 2 G}^{min} \leq {P}_{P 2 G}^{i , t} \leq {P}_{P 2 G}^{max} \qquad ( 19 )$$
where, P_{P2G}^{min} is a minimum operating power of the P2G device; P_{P2G}^{max} is a maximum operating power of the P2G device;
a power at which the P2G device to generate natural gas by means of hydrogen and carbon dioxide by consuming power is:
$${V}_{P 2 G}^{i , t} = α {P}_{P 2 G}^{i , t} \qquad ( 20 )$$
where, V_{P2G}^{i,t} is a gas generation power of the P2G device; α is a power-to-gas efficiency coefficient; P_{P2G}^{i,t} is a power of the P2G device;
the quantity of carbon dioxide acquired by the P2G device from CCS to generate natural gas under a certain power of the P2G device is:
$${W}_{CCS}^{i , t} = β {P}_{P 2 G}^{i , t} \qquad ( 21 )$$
where, W_{ccs}^{i,t} is the quantity of carbon dioxide required by the P2G device under the power P_{P2G}^{i,t}; β is a coefficient of relationship between W_{CCS}^{i,t} and P_{P2G}^{i,t};
a range constraint of the quantity of captured carbon dioxide is:
$$0 \leq {W}_{CCS}^{i , t} \leq {W}_{CCS}^{max} \qquad ( 22 )$$
where, W_{CCS}^{max} is a maximum quantity of carbon dioxide captured by the CCS, which is equal to carbon emission in a park;
carbon dioxide captured by the CCS is supplied to the P2G device, and a relationship between the power of the CCS and carbon dioxide required by the P2G device is:
$${P}_{CCS}^{i , t} = γ {W}_{CCS}^{i , t} \qquad ( 23 )$$
where, γ is a coefficient of relationship between P_{CCS}^{i,t} and W_{C02}^{i,t};
a constraint of the natural gas consumption of the CHP unit is:
$${P}_{load}^{i , t} + {P}_{CCS}^{i , t} + {P}_{P 2 G}^{i , t} = {λ}_{CHP} {V}_{CHP}^{i , t} \qquad ( 24 )$$
where, λ_{CHP} is a coefficient of relationship between the power generation and the natural gas consumption of the CHP unit;
a constraint of gas consumption of a gas boiler is:
$${H}_{GB}^{i , t} = {λ}_{GB} {V}_{GB}^{i , t} \qquad ( 25 )$$
where, Δ_{GB} is a coefficient of relationship between the heat generation rate and a natural gas consumption rate of the gas boiler;
a constraint of a total natural gas consumption rate of microgrids is:
$${V}_{i , t} = {V}_{CHP}^{i , t} + {V}_{GB}^{i , t} - {V}_{P 2 G}^{i , t} \qquad ( 26 )$$
where, Vᵢ,t is a gas consumption power of the microgrid i at the time t;
an upper and lower boundary constraint of heat production of the boiler is:
$$0 \leq {H}_{GB}^{i , t} \leq {H}_{GB}^{max} \qquad ( 27 )$$
where, H_{GB}^{i,t} is a heat generation rate of the boiler; H_{GB}^{max} is a maximum value of the heat generation rate of the boiler.

4. The shared energy storage system optimization method for comprehensive energy microgrids according to claim 1, wherein the method takes into account a carbon emission and trading model, and the shared energy storage-multi-microgrid system comprises the carbon emission and trading model, and in the carbon emission and trading model:
a CHP unit generates carbon dioxide during operation, a gas boiler discharges carbon dioxide when producing heat, and a CSS is able to reduce direct emission of carbon dioxide; therefore, carbon dioxide emission of microgrids is obtained by subtracting carbon dioxide captured by the CCS from the sum of carbon dioxide generated by the CHP unit and carbon dioxide generated by the gas boiler;
$${W}_{i , t} = δ ( {P}_{load}^{i , t} + {P}_{CCS}^{i , t} + {P}_{P 2 G}^{i , t} + {k}_{1} {H}_{CHP}^{i , t} ) + ε {H}_{GB}^{i , t} - {W}_{CCS}^{i , t} \qquad ( 28 )$$
W_{i,t} is carbon emission of a microgrid i at a time t; δ is a coefficient of relationship between a power generation rate of the CHP unit and carbon dioxide; k₁ is an electrothermal conversion coefficient in case of a minimum power generation rate of the CHP unit; ε is a carbon dioxide emission coefficient of the gas boiler; H_{GB}^{i,t} is a heat generation rate of the boiler;
carbon emission of the comprehensive energy microgrids in one day is:
$${W}_{i} = {{\sum }_{t ∈ 1}}^{24} {W}_{i , t} \qquad ( 29 )$$
Wᵢ is carbon emission of the comprehensive energy microgrid i in one day;
carbon trading is an economic means for reducing carbon emission based on trading of carbon emission permits by defining carbon credits; a carbon quota, also referred to the carbon emission permit, is the quantity of carbon dioxide permitted to be discharged; the carbon quota of the microgrids is:
$${W}_{i , allo} = η {\sum }_{t = 1}^{24} {P}_{load}^{i , t} + {P}_{CCS}^{i , t} + {P}_{P 2 G}^{i , t} + {H}_{GB}^{i , t} \qquad ( 30 )$$
where, W_{i,allo} is the carbon quota previously allocated to the microgrid i; η is a carbon quota allocation parameter;
a relationship between the carbon emission, the carbon quota and the carbon trading is:
$${W}_{i} - {W}_{i , allo} = {W}_{i , 0} + {\sum }_{j = 1}^{j = N} {W}_{buy}^{i , j} \qquad ( 31 )$$
$${W}_{i , 0} \leq 0 \qquad ( 32 )$$
where, Wᵢ is the carbon emission of the microgrid i; W_{i,allo} is the carbon quota of the microgrid i, W_{i,0} is a carbon quota for sale of the microgrid; W_{buy}^{i,j}, is a carbon quota bought by the microgrid i within an interval j;
heat of the microgrids is from a CHP system and the gas boiler, and a heat power balance constraint of the microgrids is:
$${H}_{CHP}^{i , t} + {H}_{GB}^{i , t} = H l o a {d}_{adjust}^{i , t} \qquad ( 33 )$$
where, H_{CHP}^{i,t} is a heat generation rate of the CHP unit; H_{GB}^{i,t} is a heat generation rate of the boiler; Hload_{adjust}^{i,t} is a heat load power after a demand response;
constraints of the quantity of power bought from and sold to shared energy storage (SES) by the microgrids are:
$$0 \leq {P}_{{sell}_{toS}}^{i ,} \leq {P}_{{sell}_{toS}}^{max} * flag \qquad ( 34 )$$
$$0 \leq {P}_{{buy}_{fS}}^{i , t} \leq {P}_{{buy}_{fS}}^{max} * ( 1 - flag ) \qquad ( 35 )$$
where, p_{sell_toS}^{i,t} is a selling power between the microgrid i and the SES at the time t; p_{s_buy_fS}^{i,t} is a buying power between the microgrid i and the SES at the time t; P_{sell_toS}^{max} is a maximum selling power between the microgrids and the SES; P_{buy_fS}^{max} is a maximum buying power between the microgrids and the SES; flag is a power buying/selling flag, which is 0 or 1; when flag is 0, only power buying is allowed; when flag is 1, only power selling is allowed; in this way, only power selling or power buying is allowed at a same time.

5. The shared energy storage system optimization method for comprehensive energy microgrids according to claim 1, wherein the cost model of microgrids in the shared energy storage-multi-microgrid system comprises a power/gas buying cost of the microgrids, a demand response cost of the microgrids, a carbon trading cost and an operating cost of CHP units in the microgrids:
the power/gas buying cost of the microgrids is:
$${C}_{buy}^{i} = {\sum }_{t = 1}^{t = 24} {P}_{{buy}_{fS}}^{i , t} * {γ}_{{e}_{buy}}^{i , t} - {P}_{s e l {l}_{t o G}}^{i , t} * {γ}_{{e}_{s e l l}}^{i , t} + {\sum }_{t = 1}^{t = 24} {V}_{i , t} * {γ}_{G a s} \qquad ( 36 )$$
where, C_{buy}ⁱ is the power/gas buying cost of a microgrid i; γ_{e_buy}^{i,t} is a price at which the microgrid i buys power from shared energy storage at a time t; γ_{e_sell}^{i,t} is a price at which the microgrid i sells power to the shared energy storage at the time t; γ_{Gas} is a price of natural gas;
the demand response cost of the microgrids is:
$${C}_{Dr}^{i} = {C}_{1} {\sum }_{t = 1}^{T} E l o a {d}_{cut}^{i , t} + {C}_{2} {\sum }_{t = 1}^{T} \vert {Eload}_{transfer}^{i , t} \vert + {C}_{3} {\sum }_{t = 1}^{T} H l o a {d}_{cut}^{i , t} \qquad ( 37 )$$
where, C_{Dr}ⁱ is the demand response cost of the microgrid i; C₁ is a cost coefficient of power load reduction of the microgrid i at the time t; C₃ is a cost coefficient of heat load reduction of the microgrid i at the time t;
the carbon trading cost is:
$${C}_{c a r b o n}^{i} = {W}_{i , 0} * {γ}_{s e l {l}_{c a r b o n}} + {\sum }_{j = 1}^{N} {γ}_{{buy}_{carbon}}^{j} {W}_{buy}^{i , j} \qquad ( 38 )$$
where, C_{carbon}ⁱ is the carbon trading cost of the microgrid i; γ_{sell_carbon} is a carbon quota selling price; γ_{buy_carbon}ⁱ is a carbon quota buying price at a time j; N is a maximum interval number of carbon trading intervals;
the operating cost of the CHP units in the microgrids is:
$${C}_{CHP}^{i} = {\sum }_{t = 1}^{T} {a}_{1} ( {P}_{load}^{i , t} + {P}_{CCS}^{i , t} + {P}_{P 2 G}^{i , t} ) + {\sum }_{t = 1}^{T} {a}_{2} {P}_{CCS}^{i , t} + {\sum }_{t = 1}^{T} {a}_{3} {P}_{P 2 G}^{i , t} \qquad ( 39 )$$
where, C_{CHP}ⁱ is the operating cost of the CHP unit in the microgrid i; α₁ is a power generation cost coefficient of the microgrid i at the time t; α₂ is an operating cost coefficient of a CCS; α₃ is an operating cost coefficient of a P2G device;
the cost model of the microgrids is:
$${C}_{i} = {C}_{buy}^{i} + {C}_{Dr}^{i} + {C}_{carbon}^{i} + {C}_{CHP}^{i} \qquad ( 40 )$$
where, Cᵢ is a cost of the microgrid i;
an objective function of the cost model is:
$$min {\sum }_{i} {C}_{i} \qquad ( 41 )$$
an optimal value of the objective function under the constraints is resolved by a MILP algorithm.

6. A shared energy storage system optimization system for comprehensive energy microgrids, comprising:
a model construction unit configured to store the cost model and constraints of the shared energy storage-multi-microgrid system in the shared energy storage system optimization method for comprehensive energy microgrids according to claim 1;
a calculation unit configured to resolve an optimal value of the cost model by a MILP algorithm; and
a control unit configured to control devices in the shared energy storage-multi-microgrid system according to the optimal value obtained by the calculation unit.
